(19) United States
(12) Patent Application Publication
(10) Pub. No.: US 2010/0192222 A1
(43) Pub. Date: Jul. 29, 2010

(54) MALWARE DETECTION USING MULTIPLE CLASSIFIERS

(75) Inventors: Jack W. Stokes, North Bend, WA (US); John C. Platt, Redmond, WA (US); Jonathan M. Keller, Seattle, WA (US); Joseph L. Faulhaber, Redmond, WA (US); Anil Francis Thomas, Redmond, WA (US); Adrian M. Marinescu, Sammamish, WA (US); Marius G. Gheorghescu, Redmond, WA (US); George Chicioreanu, Redmond, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/358,246

(22) Filed: Jan. 23, 2009

(51) Int. Cl. G06F 21/00; G06G 7/62; G06F 17/30; G06F 9/455

(52) U.S. Cl. 726/22; 703/13; 703/23; 707/E17.01; 707/E17.032

(57) ABSTRACT

A method of identifying a malware file using multiple classifiers is disclosed. The method includes receiving a file at a client computer. The file includes static metadata. A set of metadata classifier weights are applied to the static metadata to generate a first classifier output. A dynamic classifier is initiated to evaluate the file and to generate a second classifier output. The method includes automatically identifying the file as potential malware based on at least the first classifier output and the second classifier output.

### BACKGROUND

Protecting computers from security threats, such as malware, is a concern for modern computing environments. Malware includes unwanted software that attempts to harm a computer or a user. Different types of malware include trojans, keyloggers, viruses, backdoors and spyware. Malware authors may be motivated by a desire to gather personal information, such as social security, credit card, and bank account numbers. Thus, there is a financial incentive motivating malware authors to develop more sophisticated methods for evading detection. In addition, various techniques, such as packing, polymorphism, or metamorphism can create a large number of variants of a malicious or unwanted program. Thus, it is difficult for security analysts to identify and investigate each new instance of malware.

### SUMMARY

The present disclosure describes malware detection using multiple classifiers including static and dynamic classifiers. A static classifier applies a set of metadata classifier weights to static metadata of a file. Examples of dynamic classifiers include an emulation classifier and a behavioral classifier. The classifiers can be executed at a client to automatically identify the file as potential malware and to potentially take various actions. For example, the actions may include preventing the client from running the malware, alerting a user to the possible presence of malware, querying a web service for additional information on the file, performing more extensive automated tests at the client to determine whether the file is indeed malware, or recommending that the user submit the file for further analysis. Classifiers can also be executed at a backend service to evaluate a sample of the file, to prioritize new files for human analysts to investigate, or to perform more extensive analysis on particular files. Further, based on further analysis, a recommendation may be provided to the client to block particular files.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram to illustrate a first particular embodiment of a system to classify a file;

FIG. 2 is a block diagram to illustrate a second particular embodiment of a system to classify a file;

FIG. 3 is a flow diagram to illustrate a first particular embodiment of a method of identifying a malware file using multiple classifiers;

FIG. 4 is a flow diagram to illustrate a second particular embodiment of a method of identifying a malware file using multiple classifiers;

FIG. 5 is a flow diagram to illustrate a third particular embodiment of a method of identifying a malware file using multiple classifiers;

FIG. 6 is a flow diagram to illustrate a fourth particular embodiment of a method of identifying a malware file using multiple classifiers;

FIG. 7 is a flow diagram to illustrate a fifth particular embodiment of a method of identifying a malware file using multiple classifiers;

FIG. 8 is a block diagram to illustrate a first particular embodiment of a hierarchical static malware classification system;

FIG. 9 is a block diagram to illustrate a first particular embodiment of an aggregated static classification system;

FIG. 10 is a block diagram to illustrate a first particular embodiment of a hierarchical behavioral malware classification system;

FIG. 11 is a block diagram to illustrate a first particular embodiment of an aggregated behavioral classification system;

FIG. 12 is a flow diagram to illustrate a particular embodiment of a client side malware identification method;

FIG. 13 is a flow diagram to illustrate a first particular embodiment of a server side malware identification method;

FIG. 14 is a flow diagram to illustrate a second particular embodiment of a server side malware identification method; and

FIG. 15 is a block diagram of an illustrative embodiment of a general computer system.

### DETAILED DESCRIPTION

In a particular embodiment, a method of identifying a malware file using multiple classifiers is disclosed. The method includes receiving a file at a client computer. The file includes static metadata. A set of metadata classifier weights are applied to the static metadata to generate a first classifier output. A dynamic classifier is initiated to evaluate the file and to generate a second classifier output. The method includes automatically identifying the file as potential malware based on at least the first classifier output and the second classifier output.

In another particular embodiment, a method of classifying a file is disclosed. The method includes receiving a file at a client computer. The method also includes initiating a static type of classification analysis on the file, initiating an emulation type of classification analysis on the file, and initiating a behavioral type of classification analysis on the file. The method includes taking an action with respect to the file based on a result of at least one of the static type of classification analysis, the emulation type of classification analysis, and the behavioral type of classification analysis.

In another particular embodiment, a system to classify a file is disclosed. The system includes a classifier report evaluation component and a hierarchical classifier component. The classifier report evaluation component receives and evaluates a plurality of classifier reports from a set of client computers. The hierarchical classifier component includes a metadata classifier to evaluate metadata of a file sampled by at least one of the client computers to generate a first classifier output. The hierarchical classifier component also includes a dynamic classifier to generate a second classifier output. The hierarchical classifier component also includes a classifier results output to provide an aggregated output related to predicted malware content of at least one file associated with at least one of the plurality of classifier reports.

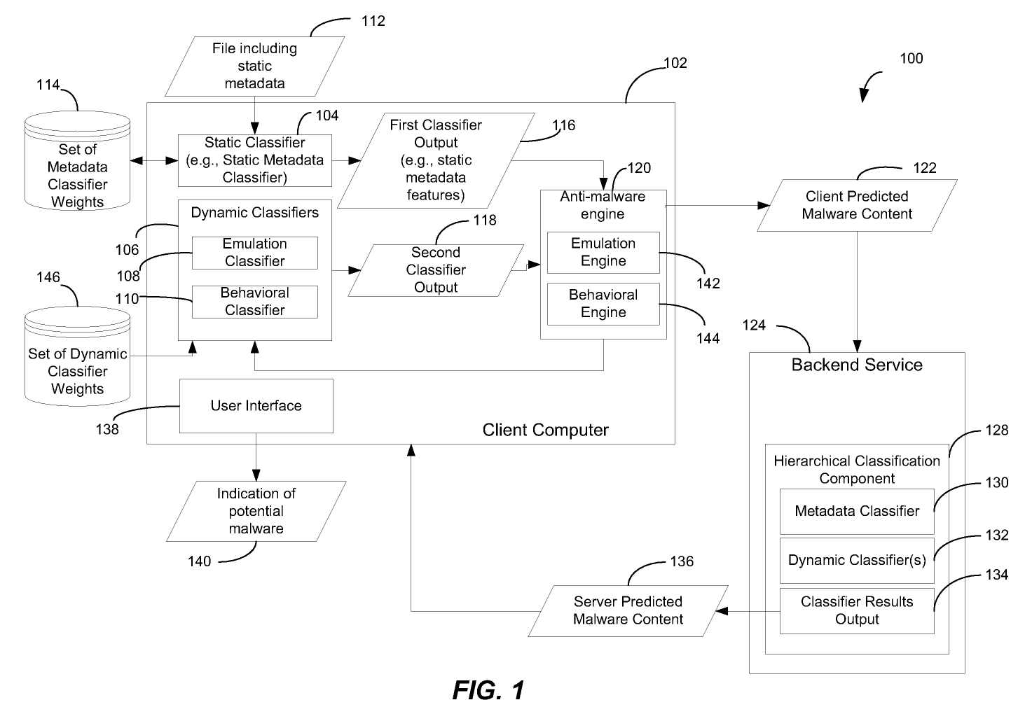

Referring to FIG. 1, a block diagram of a first particular embodiment of a system 100 to classify a file is illustrated. Multiple statistical classifiers can be used to implement a malware detection system that runs on a client computer. Further, a separate architecture is disclosed that can be run as a backend service. As used herein, the term malware includes trojans, keyloggers, viruses, backdoors, spyware, and potentially unwanted software, among other possibilities.

In the embodiment illustrated in FIG. 1, the system 100 includes a client computer 102 and a backend service 124. The client computer 102 includes a static classifier (e.g., a static metadata classifier 104), one or more dynamic classifiers 106, and an anti-malware engine 120. The anti-malware engine 120 may include an emulation engine 142 and a behavioral engine 144. For example, the dynamic classifiers 106 may include an emulation classifier 108 and a behavioral classifier 110. The client computer 102 may be connected to the backend service 124 via a network (e.g., the Internet). The backend service 124 includes a hierarchical classification component 128 that includes a backend metadata classifier 130 (e.g., a static metadata classifier or other metadata classifiers) and one or more backend dynamic classifiers 132. For example, the backend dynamic classifiers 132 may include a backend emulation classifier and a backend behavioral classifier.

In operation, the client computer 102 receives a file 112 including static metadata. The static metadata classifier 104 applies a set of metadata classifier weights 114 to the static metadata of the file 112 to generate a first classifier output 116. In a particular embodiment, the set of metadata classifier weights 114 are stored locally at the client computer 102. Alternatively, the set of metadata classifier weights 114 may be stored at another location (e.g., a network location). One or more dynamic classifiers 106 are then initiated to evaluate the file 112 and to generate a second classifier output 118. Based on at least the first classifier output 116 and the second classifier output 118, the anti-malware engine 120 automatically determines whether the file 112 includes potential malware. When the file 112 includes potential malware, a user interface 138 may provide an indication of potential malware 140 to a user.

The static metadata classifier 104 applies the set of metadata classifier weights 114 to generate the first classifier output 116. The static metadata classifier 104 analyzes attributes of the file 112 to construct features. Examples of static metadata features at the client computer 102 include a checkpointID feature and a locality sensitive hash feature. The checkpointID feature includes what behavior caused the report to be generated. The locality sensitive hash feature is a locality sensitive hash where a small change in the executable binary of a file leads to a small change in the locality sensitive hash. Weights 114 for the static metadata classifier 104 are trained on a backend system (e.g., the backend service 124) using metadata reports from many clients and the associated analyst labels (e.g., malware, benign). Training a two-class (malware, benign software) classifier using logistic regression may provide very accurate results.

The trained classifier weights may then be downloaded to the client computer 102 and stored as the set of metadata classifier weights 114. Attributes are extracted from the file 112 and converted to static metadata features. The static metadata features are evaluated by the static metadata classifier 104. The first classifier output 116 from the static metadata classifier 104 indicates a measure related to how likely the file 112 is to be malware.

Thus, the set of metadata classifier weights 114 may be used to produce a statistical likelihood that particular metadata is associated with malware. This statistical likelihood is output from the static metadata classifier 104 as the first classifier output 116. In a particular embodiment, the static metadata is represented as a feature vector. The first classifier output 116 may be determined based at least in part on a dot product of the set of metadata classifier weights 114 and the feature vector.

Another type of static classifier that predicts a likelihood that an unknown file is malware is a static string classifier that evaluates strings found in an unknown file, such as the file 112. One type of static string classifier uses a bag of strings model where important strings discriminate benign files and malware files. These strings can be identified in a number of different ways using feature selection techniques based on different principles such as contingency tables, mutual information, or other metrics. Once the most informative strings have been identified, a classifier can then be trained based on the presence or absence of the strings from known examples of the desired classes. When an unknown file is encountered, the anti-malware engine 120 extracts all strings from the unknown file. The anti-malware engine 120 compares each of the feature selected strings to the strings extracted from the unknown file. If the classifier feature string occurs in the unknown file, this feature is set to TRUE. Otherwise, this feature is set to FALSE. Alternatively, the number of times the particular string occurs in the unknown file may also be used as a feature instead of or in addition to the absence or presence of the string. The static string classifier then produces an output related to the likelihood that the unknown file is malware.

Another type of static classifier that predicts a likelihood that an unknown file, such as the file 1 12, is malware is a static code classifier. For example, the static code classifier may be based on blocks of code used by the file 112.

As shown in FIG. 1, the client computer 102 includes one or more dynamic classifiers 106. The dynamic classifiers 146 may receive one or more dynamic classifier weights from a set of dynamic classifier weights 146. After the static metadata classifier 104 produces the first classifier output 116, the dynamic classifiers 106 may be initiated to evaluate the file 112 and to generate the second classifier output 118. In a particular embodiment, one or more of the dynamic classifiers 106 are initiated after the static metadata classifier 104 does not identify potential malware. Thus, the dynamic classifiers 106 may be used to supplement the static testing performed by the static metadata classifier 104. Alternatively, when the static metadata classifier 104 determines that the file includes potential malware, the dynamic classifiers 106 may be used as an additional test to determine whether the file 112 includes malware.

In a particular embodiment, the emulation classifier 108 simulates execution of the file 112 in an emulation environment. The emulation environment protects the client computer 102 from being infected while the file 112 is tested in the emulation environment. In the emulation environment, the anti-malware engine 120 observes the behavior exhibited by the tested file 112 as it “runs” in the emulation environment. The behavior the file 112 exhibits will be very similar to the behavior it would exhibit if the file 112 were to run in the real system (e.g., the client computer 102). If the file 112 is found to be malware, this technique allows the anti-malware engine 120 to block the file before the file is allowed to execute. In a particular embodiment, the first classifier output 116 from the static metadata classifier 104 may be used to determine the length of time that the emulation classifier 108 is run.

The anti-malware engine 120 can observe which system APIs are invoked by the malware and what parameters are passed to these APIs. For example, the emulation classifier 108 may determine a set of application programming interfaces (APIs) invoked at the emulation environment. In a particular embodiment, features used by the emulation classifier 108 include API and parameter combinations, unpacked strings, and n-grams of API sequence calls. At least one of the APIs may be associated with malware. If the emulation classifier 108 predicts that the file 112 is malware, the installation and execution of the file 112 may be blocked.

The behavioral classifier 110 may be composed of one or more classifiers that analyze an unknown file, such as file 112, during installation and execution. In a particular embodiment, the behavioral classifier 110 analyzes the file 112 during installation to identify one or more installation behavioral features associated with malware. When there is a request to install an unknown file (e.g., the file 112) on the client computer 102, the behavioral classifier 110 predicts whether the file 112 is malware or benign based on behavior exhibited by the file 112 during installation. If the behavioral classifier 110 predicts that the file 112 is malware before the installation process has completed, the behavioral classifier 110 may be able to alert the operating system in time to prevent the malware from being installed, thereby preventing infection of the client computer 102.

In another particular embodiment, the behavioral classifier 110 analyzes the file 112 during run-time to identify one or more run-time behavioral features associated with malware. After the file 112 has been installed, the behavioral classifier 110 can attempt to predict if the file 112 is malware based on its normal behavior. If the behavioral classifier 110 predicts that the file 112 is malware, the execution of the file 112 can be halted.

The behavioral classifier 110 can also be used to predict whether the file 112 is malware based on other types of behavior. For example, the behavioral classifier 110 may monitor an operating system firewall or a corporate network firewall and prohibit the execution of the file 112 based on external network behavior.

Based on at least the first classifier output 116 and the second classifier output 118, the anti-malware engine 120 may take an action with respect to the file. For example, the action may include providing an indication of potential malware 140 to a user via the user interface 138. Alternatively, the action may include blocking execution of the file 112 or blocking installation of the file 112. In another embodiment, the action may include querying a web service for additional information about the file 112. For example, the anti-malware engine 120 may submit client predicted malware content 122 to the backend service 124. The client predicted malware content 122 may include classifier information and metadata related to the file 112. The backend service 124 may perform additional emulation type classification analysis to determine whether the file 112 includes malware. In the embodiment shown, the backend service 124 includes a hierarchical classification component 128, including a backend metadata classifier component 130, one or more backend dynamic classifiers 132, and a classifier results output component 134. Based on an analysis by at least one of the components 130 and 132, the backend service 124 may provide server predicted malware content 136 to the client computer 102. For example, the server predicted malware content 136 may indicate that the file 112 contains malware. Alternatively, the server predicted malware content 136 may indicate that the file 112 does not contain malware.

In a particular embodiment, there are two backend static metadata classifiers: Zero-Day Backend Static Metadata Classifier (ZDBSMC) and Aggregated Backend Static Metadata Classifier (ABSMC). The ZDBSMC is designed to detect a new malware entry the first time it is encountered. Examples of ZBSMC and ABSMC features include a checkpointID feature, a locality sensitive hash feature, a packed feature, and a signer feature, among other alternatives. The checkpointID feature includes what behavior caused the report to be generated. The locality sensitive hash feature is a locality sensitive hash where a small change in the executable binary of a file leads to a small change in the locality sensitive hash.

An anti-malware system can be executed on many client machines at various locations. These anti-malware engines can generate classifier reports that describe either static attributes, dynamic behavioral (both emulated and real system) attributes, or a combination of both static and dynamic behavioral attributes. These reports can optionally be transmitted to a backend service implemented on one or more backend servers. The backend service can determine whether or not to store the classifier reports from the anti-malware engines.

Backend anti-malware services attempt to identify new forms of malware and request samples of new malware that are encountered by client computers. However, many forms of malware are polymorphic or metamorphic, meaning that these files sometime mutate so that each instance (i.e. variant) of the malware is unique. If the backend anti-malware service waits to collect a sample of polymorphic or metamorphic malware based on post processing of the metadata reports, variants of polymorphic or metamorphic malware may be detected from metadata reports, but the unique samples may not be seen again on another computer.

If the static, emulation and/or behavioral classifiers predict that the unknown file is malware, the classification output probability from the classifier(s) on the client can be sent to the backend service 124 along with the other metadata. If the unknown file is predicted to be malware by the client and the backend service 124 has either never received a particular report for the unknown file or has not received the desired number of reports related to the particular file, then the backend service 124 can automatically request that the sample be collected from the client computer, such as the client computer 102. The client computer 102 may also use the classification output probability to decide whether or not to automatically push a sample of the file 112 to the backend service 124.

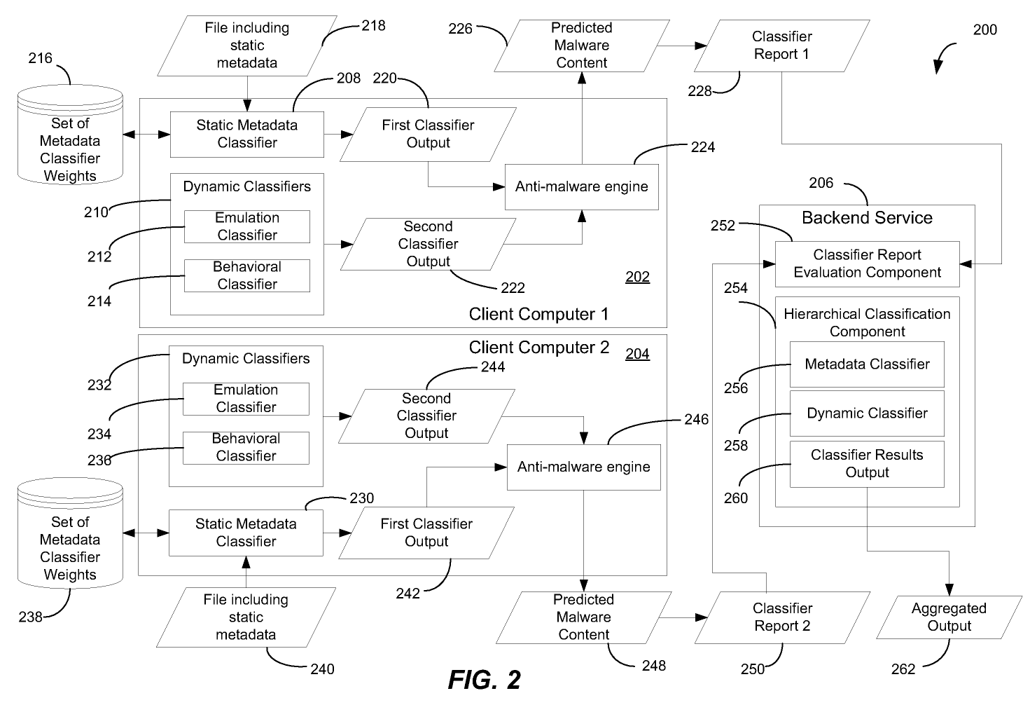

Referring to FIG. 2, a block diagram of a second particular embodiment of a system 200 to classify a file is illustrated. The system 200 includes a backend service 206 that may be used to identify and prioritize potentially malicious files, to request a sample of an unknown file, to rank programs for human analysts to investigate, and to perform more extensive automated tests. The backend service 206 includes a classifier report evaluation component 252 to receive and evaluate a plurality of classifier reports from client computers. For example, in the illustrated embodiment, the classifier report evaluation component 252 receives a first classifier report 228 from a first client computer 202 and a second classifier report 250 from a second client computer 204. The backend service 206 may receive classifier reports from multiple client computers. The backend service 206 also includes a hierarchical classifier component 254. The hierarchical classification component 254 includes a metadata classifier 256 (e.g., a static metadata classifier or other metadata classifiers), at least one dynamic classifier 258, and a classifier results output 260. For example, the at least one dynamic classifier 258 may include an emulation classifier and a behavioral classifier. In a particular embodiment, one or more backend dynamic classifiers 258 may be more extensive and may consume more resources than lightweight classifier versions running on client computers (e.g., the client computers 202 and 204).

The metadata classifier 256 evaluates metadata sampled by at least one of the client computers to generate a first classifier output. For example, the metadata may include static metadata or other metadata (e.g., dynamic metadata). As an example, behavioral metadata and emulation metadata may be transferred to the backend service 206. If a sample file has been previously collected, a more extensive metadata classifier 256 may be run (e.g., static metadata, code, or string classifiers). The dynamic classifier 258 generates a second classifier output. In a particular embodiment, the dynamic classifier 258 is run if a sample has been previously collected. The classifier results output 260 provides an aggregated output 262 related to predicted malware content of at least one file associated with at least one of the plurality of classifier reports (e.g., the first classifier report 228 and the second classifier report 250). In a particular embodiment, each of the classifier reports may include at least one of a filename, an organization, and a version.

The classifiers 256 and 258 at the backend service 206 may be similar to the classifiers that are executable at client computers (e.g., the first client computer 202 and the second client computer 204). For example, the metadata classifier 256 of the backend service 206 can classify new reports that are collected from the anti-malware engines running on the client (e.g., anti-malware engine 224 on the first client computer 202 and anti-malware engine 246 on the second client computer 204).

In operation, the backend service 206 receives classifier reports from one or more client computers. In the embodiment illustrated, the client computers include the first client computer 202 and the second client computer 204. The first client computer 202 includes a static metadata classifier 208, one or more dynamic classifiers 210, and an anti-malware engine 224. The dynamic classifiers 210 include an emulation classifier 212 and a behavioral classifier 214.

The first client computer 202 receives a file 218 including at least static metadata (e.g., the file 218 may also contain dynamic metadata). The static metadata classifier 208 applies a set of metadata classifier weights 216 to the static metadata from the file 218 to generate a first classifier output 220. The dynamic classifiers 210 are then initiated to evaluate the file 218 and to generate a second classifier output 222. Based on at least the first classifier output 220 and the second classifier output 222, the anti-malware engine 224 automatically determines whether the file 218 includes potential malware.

The second client computer 204 operates substantially similarly to the first client computer 202. The second client computer 204 includes a static metadata classifier 230, one or more dynamic classifiers 232, and an anti-malware engine 246. The dynamic classifiers 232 include an emulation classifier 234 and a behavioral classifier 236. The second client computer 204 receives a file 240 including static metadata. The static metadata classifier 230 applies a set of metadata classifier weights 238 to the static metadata from the file 240 to generate a first classifier output 242.

In a particular embodiment, the set of metadata classifier weights 238 are stored locally at the second client computer 204. Alternatively, the set of metadata classifier weights 238 may be stored at another location. For example, the set of metadata classifier weights 238 may be stored at a network location and shared by the first client computer 202 and the second client computer 204.

The dynamic classifiers 232 are initiated to evaluate the file 240 and to generate a second classifier output 244. Based on at least the first classifier output 242 and the second classifier output 244, the anti-malware engine 246 automatically determines whether the file 240 includes potential malware.

Based on at least the classifier outputs 220, 222, 242 and 244, the anti-malware engines 224 and 246 submit client predicted malware content 226, 248 to the backend service 206. The client predicted malware content 226 from the first client computer 202 may be included in the first classifier report 228. Similarly, the client predicted malware content 248 from the second client computer 204 may be included in the second classifier report 250.

Backend static malware classification may have some advantages over the client classifiers. For example, the backend metadata classifier 256 can aggregate the metadata from multiple reports. Additional aggregated features may include the number of different filenames, organizations, and versions, among other alternatives. For example, the same malware binary may use a different filename, organization, or version. An additional feature is the entropy (randomness) of the different filenames. If the filename is completely random for the same executable binary, which can be identified by a hash of the binary version of the file, such as files 218 or 240, this is often an indication of malware. Furthermore, if the checkpointID and dynamic metadata are completely random, this may be an indication of malware. As another example, additional computational processing can be used on the backend. Very fast dedicated computers can be used to analyze an unknown file on the backend server. This may allow for additional analysis of the unknown file.

Once the backend service 206 has analyzed the classifier reports (and, optionally, the unknown file) one or more of the classifier output probabilities can be returned to the client computer so that the client computer can decide whether or not to continue the installation or execution of the unknown file. In addition, when a classifier report is submitted to the backend service 206, one or more of the backend classifier output values can be used to automatically request that the file be collected immediately from the client computer or collected in the future when the file is again observed.

For an enterprise, information technology (IT) managers may desire the ability to enable full logging of files exhibiting “suspicious” static, emulation, and behavioral events. IT managers log host computer events, firewall events for monitoring network activity, etc. to investigate potential malware on their clients. An anti-malware engine can maintain a history of the behavior for the unknown files, i.e. files that are not signed by companies on a cleanlist. The anti-malware engine can provide the ability to log the behavior of clean files so that the IT managers can learn to identify clean behavior. The option to log behavior events to a SQL database may be desirable. Another feature would be to add a new set of security events to handle the behavioral events so that a backend security service could manage these events.

For a home or a small business environment, users could enable full behavior logging for “suspicious” behavioral events. Users could submit plain text versions of the logs to anti-malware forums for feedback. If suspicious behavior is detected on the client, the user could also have the option of submitting the full behavior logs to the anti-malware engine manufacturer in real-time which are obfuscated for personal information and compressed, encrypted, etc. The backend service 206 could provide a type of enhanced, behavioral reputation service similar to a diagnosis provided after a crash. The backend service could offer an enhanced diagnostic security service based on these logs which might not be available on the client in real-time. In addition to the home users, the enterprise users would also use this backend service for enhanced security. These logs would then be the basis for training future versions of behavioral based signatures and classifiers.

In both of these scenarios, the end user would have control over submitting the logs and would gain better security through improved diagnostics. Thus, the initial detection of suspicious behavior on the client based on signatures would provide the first level of detection. The backend could potentially offer more robust behavioral analysis and detection.

Another way to collect training data is to reconstruct the overall behavior event sequence for any file given partial telemetry monitoring logs. This may involve sampling and returning random, contiguous blocks of behavioral events. The backend would receive these small blocks of contiguous events from multiple clients and reconstruct the overall behavioral event patterns from these small contiguous blocks of events. This may enable a better understanding of the overall behavior of the files in the near term and enable design of better signatures and classifiers.

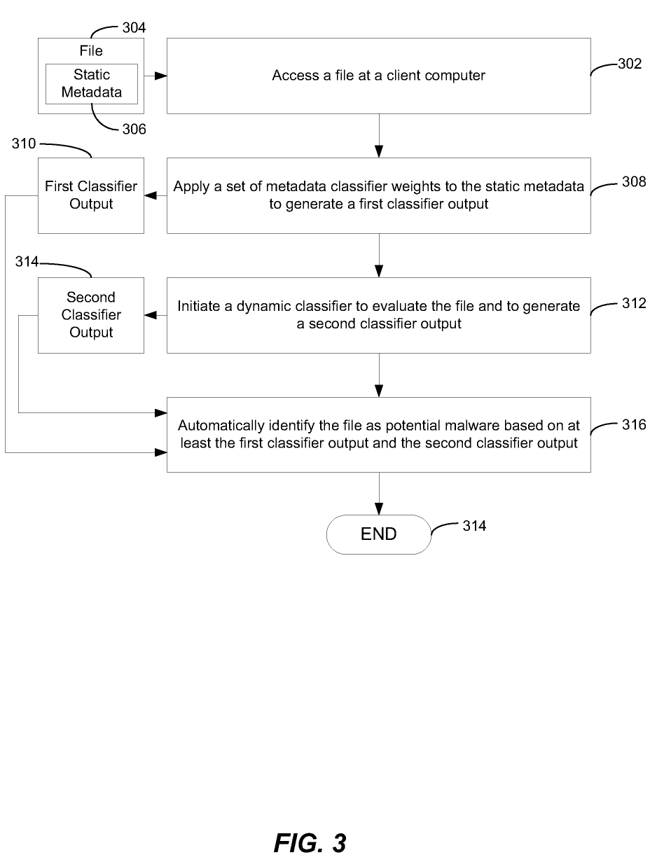

Referring to FIG. 3, a flow diagram of a first particular embodiment of a method of identifying a malware file using multiple classifiers is illustrated. The method includes receiving a file 304 at a client computer, at 302. The file 304 includes static metadata 306. For example, the file 304 may include the file 112 of FIG. 1 or the files 218 and 240 of FIG. 2. The method includes applying a set of metadata classifier weights to the static metadata, or transforming the metadata, to generate a first classifier output 310, at 308. In one implementation, transforming the metadata may include determining n-grams of a string value. In another implementation, transforming the metadata may include computing a categorical feature value from a set of k possible values for one type of metadata. For example, the first classifier output 310 may include the first classifier output 116 generated by the static metadata classifier 104 of FIG. 1, the first classifier output 220 generated by the static metadata classifier 208 of FIG. 2, or the first classifier output 242 generated by the static metadata classifier 230 of FIG. 2.

The method includes initiating a dynamic classifier to evaluate the file 304 and to generate a second classifier output 314, at 312. For example, the dynamic classifier may include the emulation classifier 108 of FIG. 1 or the emulation classifiers 212 and 234 of FIG. 2. Alternatively, the dynamic classifier may include the behavioral classifier 110 of FIG. 1 or the behavioral classifiers 214 and 236 of FIG. 2. The second classifier output 314 may include the second classifier output 118 of FIG. 1 or the second classifier outputs 222 and 244 of FIG. 2. Weights for the dynamic classifiers may also be applied (e.g., weights for the dynamic classifiers 106 of FIG. 1 and the dynamic classifiers 210 and 232 of FIG. 2).

The method also includes automatically identifying the file 304 as a potential malware file based on at least the first classifier output 310 and the second classifier output 314, as shown at 316. It should be noted that the classifiers may be run in sequence or in parallel. For example, a static classifier and an emulation classifier may be run in parallel. In a particular embodiment, the classifiers may be run in parallel using different central processing unit (CPU) cores. The method ends at 314.

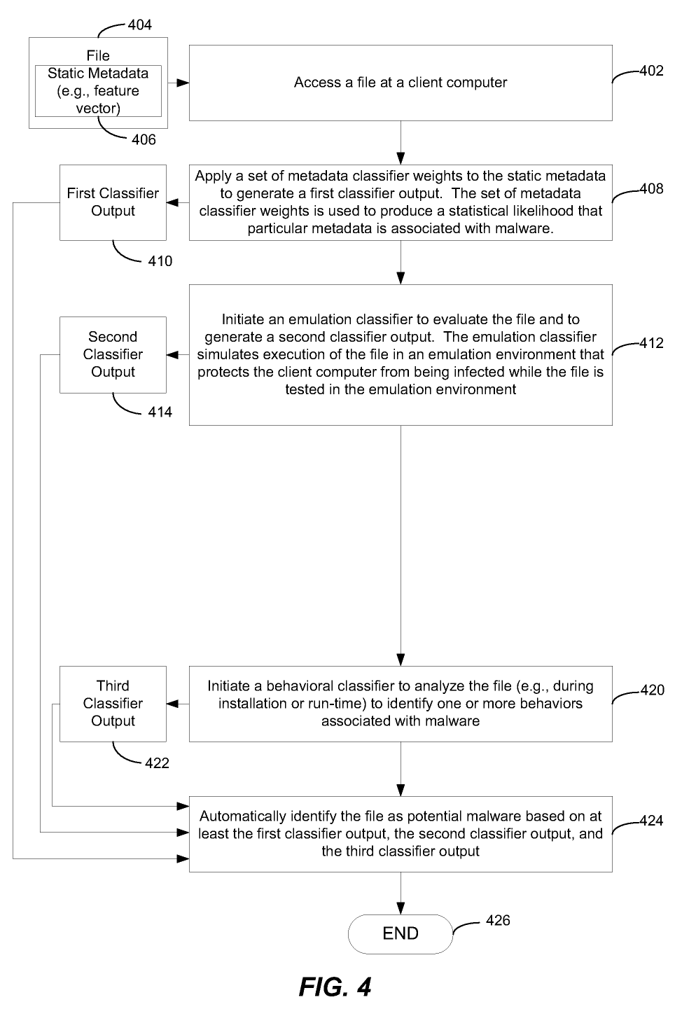

Referring to FIG. 4, a flow diagram of a second illustrative embodiment of a method of identifying a malware file using multiple classifiers is shown. The method includes receiving a file 404 at a client computer, at 402. The file 404 includes static metadata 406. The static metadata 406 may be represented as a feature vector. The method includes applying a set of metadata classifier weights to the static metadata to generate a first classifier output 410, at 408. The set of metadata classifier weights is used to produce a statistical likelihood that particular metadata is associated with malware. The first classifier output 410 may be determined, at least in part, based on a dot product of the set of metadata classifier weights and the feature vector.

The method includes initiating an emulation classifier to evaluate the file 404 and to generate a second classifier output 414, as shown at 412. For example, the emulation classifier may include the emulation classifier 108 of FIG. 1 or the emulation classifiers 212 and 234 of FIG. 2. As noted above, the emulation classifier may simulate execution of the file 404 in an emulation environment, where the emulation environment protects the client computer from being infected while the file 404 is tested. In a particular embodiment, a first list of application programming interfaces (APIs) may be determined off-line along with a second list of one or more parameters, which can differentiate between malware and benign files. Other additional features can include n-grams of seqeuences of API calls, and unpacked strings identified from the file during emulation or behavioral processing. Once the first list and the second list (which are part of the features for the emulation and behavorial classifier) have been determined, the method may include determining whether the file 404 exhibits one or more of these features during installation or during run-time in the behavioral engine (e.g., the behavioral engine 144 of FIG. 1). Classifiers may then be run on the resulting feature vectors output by the respective engines (i.e., the emulation engine 142 and the behavioral engine 144 of FIG. 1)

The method includes initiating a behavioral classifier to evaluate the file 404 and to generate a third classifier output 422, as shown at 420. For example, the behavioral classifier may include the behavioral classifier 110 of FIG. 1 or the behavioral classifiers 214 and 236 of FIG. 2. The third classifier output 422 may include the second classifier output 118 of FIG. 1 or the second classifier outputs 222 and 244 of FIG. 2.

The method also includes automatically identifying the file 404 as potential malware based on at least the first classifier output 410, the second classifier output 414, and the third classifier output 422, as shown at 424. For example, the file 404 may be identified as malware using the anti-malware engine 120 of FIG. 1 or the anti-malware engines 224 and 246 of FIG. 2. The method ends at 426.

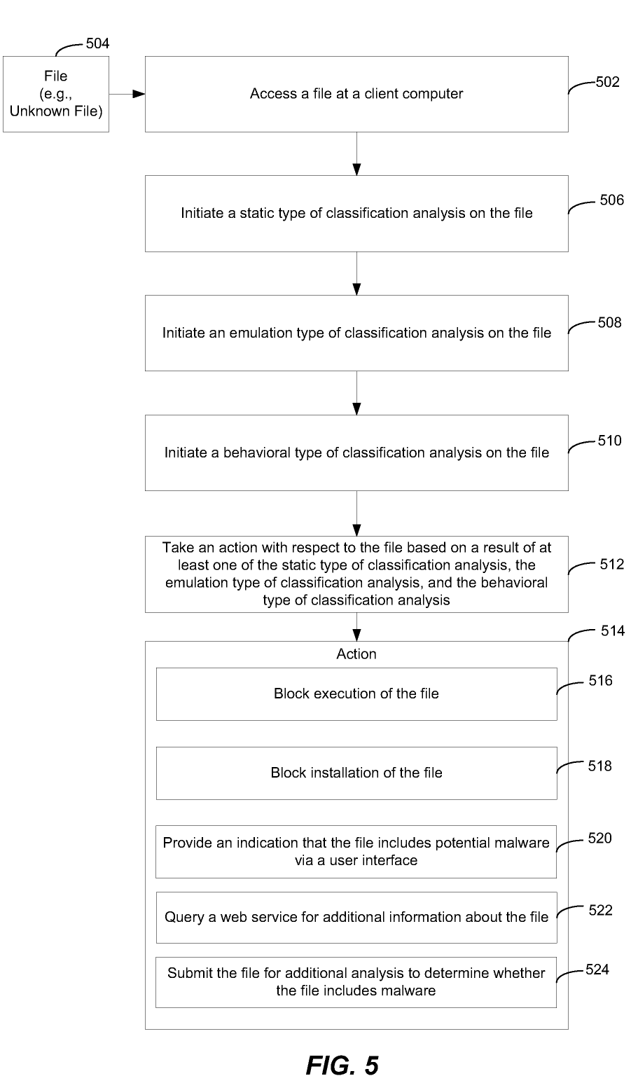

Referring to FIG. 5, a flow diagram of a third particular embodiment of a method of identifying a malware file using multiple classifiers is illustrated. In a particular embodiment, the method may be performed by a computer responsive to executable instructions stored at a computer-readable medium.

The method includes receiving a file 504 (e.g., an unknown file) at a client computer, at 502. Alternatively, a plurality of files may be received. For example, the file 504 may include the file 112 of FIG. 1 or either of the files 218 and 240 of FIG. 2. The method includes initiating a static type of classification analysis on the file 504, as shown at 506. For example, the static type classification may be performed using the static metadata classifier 104 of FIG. 1 or either the static metadata classifiers 208 and 230 of FIG. 2. The method includes initiating an emulation type of classification analysis on the file 504, as shown at 508. For example, the emulation type of classification may be performed using the emulation classifier 108 of FIG. 1 or either of the emulation classifiers 212 and 234 of FIG. 2. The method includes initiating a behavioral type of classification analysis on the file 504, as shown at 510. For example, the behavioral type classification may be performed using the behavioral classifier 110 of FIG. 1 or either of the behavioral classifiers 214 and 236 of FIG. 2. The method also includes taking an action 514 with respect to the file 504 based on a result of at least one of the static type of classification analysis, the emulation type of classification analysis, and the behavioral type of classification analysis, at 512.

For example, the action 514 may include blocking execution of the file 504, at 516, or blocking installation of the file 504, as shown at 518. As another example, the action 514 may include providing an indication that the file 504 includes potential malware via a user interface, at 520. For example, the indication may include the indication of potential malware 140 provided to a user via the user interface 138 of the client computer 102 illustrated in FIG. 1.

As an additional example, the action 514 may include querying a web service for additional information about the file 504, at 522. For example, the client computer 102 of FIG. 1 may query the backend service 124, or the client computers 202 and 204 of FIG. 2 may query the backend service 206 for additional information. As an additional example, the action 514 may include submitting the file 504 for additional emulation classification analysis to determine whether the file 504 includes malware, as shown at 524. For example, a sample of the file 504 may be submitted to the backend service 124 of FIG. 1 or to the backend service 206 of FIG. 2 for additional emulation classification analysis.

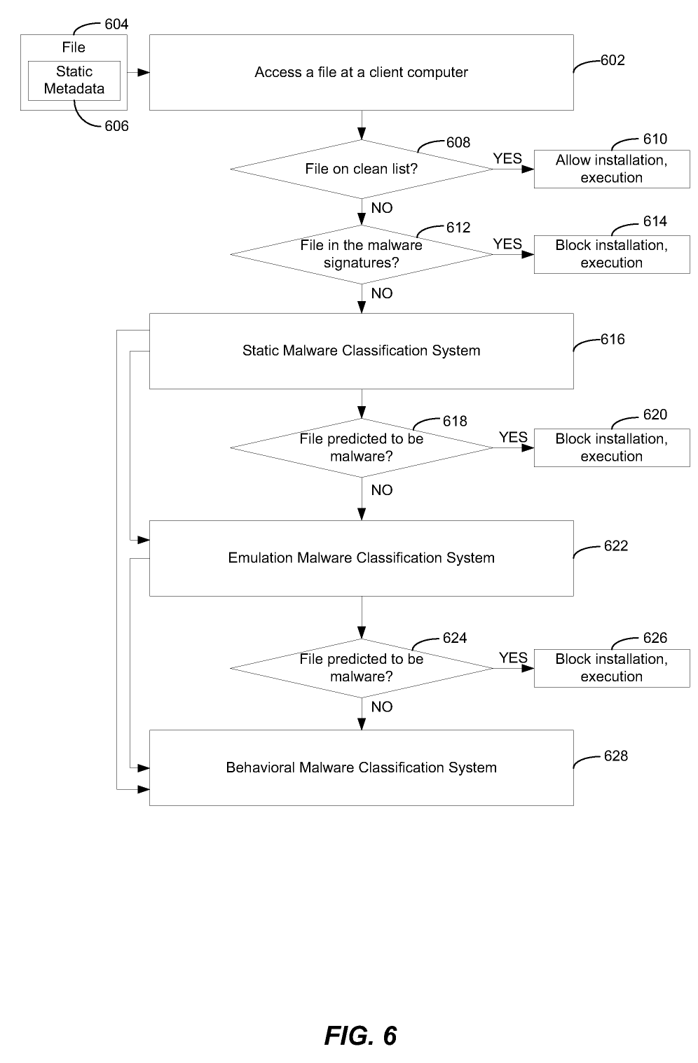

Referring to FIG. 6, a flow diagram of a fourth particular embodiment of a method of identifying a malware file using multiple classifiers is illustrated. The method includes receiving a file 604 at a client computer, as shown at 602. The file 604 includes static metadata 606. In the embodiment illustrated, the file is compared to a clean list to determine if the file is allowed to be installed and executed. If a hash of the file is included in the clean list or if the file is properly signed, then the file is allowed to be installed and executed, at 610. Next, the file can be analyzed by a malware detection engine that uses exact signatures (e.g., a specialized hashing or pattern matching technique) or generic signatures to determine if the file is a known instance of malware, at 612. If the file is identified as malware, then the installation and execution of the file is halted, at 614. Optionally, a user can be given the option of continuing installation and execution of the file.

When the file is not identified as malware, the method proceeds to a static malware classification system, at 616. If the static malware classification system predicts that the file is malware, at 618, then the installation and execution of the file is blocked, at 620. Otherwise, the method proceeds to the emulation malware classification system, at 622.

If the emulation malware classification system predicts that the file is malware, at 624, then the installation and execution of the file is blocked, at 626. Otherwise, the method proceeds to the behavioral malware classification system, at 628. The classifier features from the static malware classification system is provided to the emulation malware classification system, and the classifier features from the emulation malware classification system is provided to the behavioral malware classification system. Thus, one or more features from a previous classifier are passed to the next classifier. For example, static metadata features from the static malware classification system (e.g., checkpointID, file name) may be passed to the emulation malware classification system. Further, one or more statistical outputs from the static malware classification system may be passed to the emulation malware classification system. In addition, one or more features and the classifier outputs from the static malware classification system and the emulation malware classification system are provided to the behavioral malware classification system.

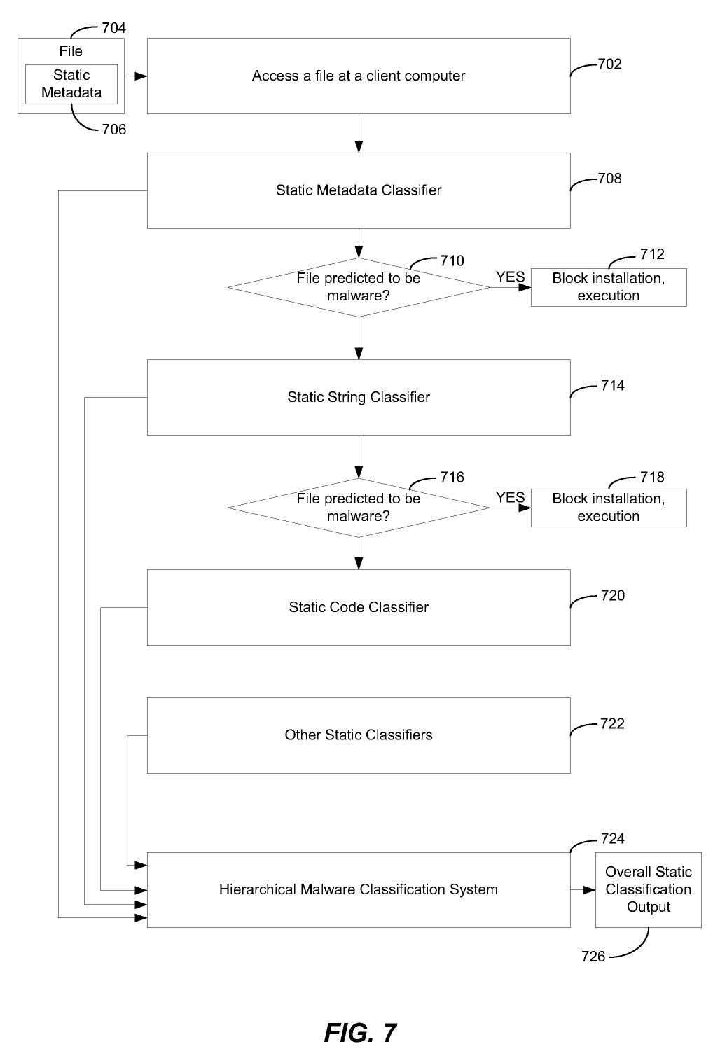

Referring to FIG. 7, a flow diagram of a fifth particular embodiment of a method of identifying a malware file using static classifiers is illustrated. The method includes receiving a file 704 at a client computer, as shown at 702. The file 704 includes static metadata 706. The file 704 is provided to a static malware classification system, as shown at 708. If the static malware classification system predicts that the file is malware, at 710, then the installation and execution of the file is blocked, at 712. Otherwise, the method proceeds to a static string classifier, at 714. If the static string classifier predicts that the file is malware, at 716, then the installation and execution of the file is blocked, at 718. Otherwise, the method proceeds to a static code classifier, at 720.

In the embodiment illustrated, the file may also be analyzed using other static classifiers, at 722. The outputs from the static malware classification system, the static string classifier, and the static code classifier are provided to a hierarchical malware classification system, at 724. The hierarchical malware classification system determines an overall static classification output 726.

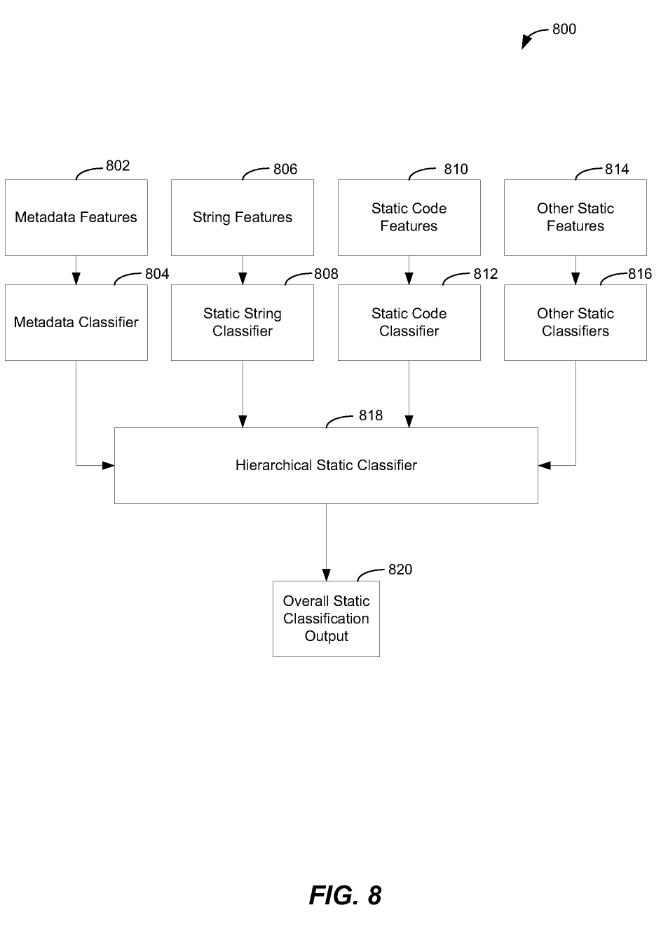

Referring to FIG. 8, a block diagram of a first particular embodiment of a hierarchical static malware classification system is illustrated. One or more metadata features 802 are provided to a metadata classifier 804. One or more string features are provided to a static string classifier 808. One or more static code features are provided to a static code classifier. Other static features 814 may be provided to other static classifiers 816. The outputs from the metadata classifier 804, the static string classifier 808, the static code classifier 812, and the other static classifiers 816 are provided to a hierarchical static classifier 818. The hierarchical static classifier 818 determines an overall static classification output 820.

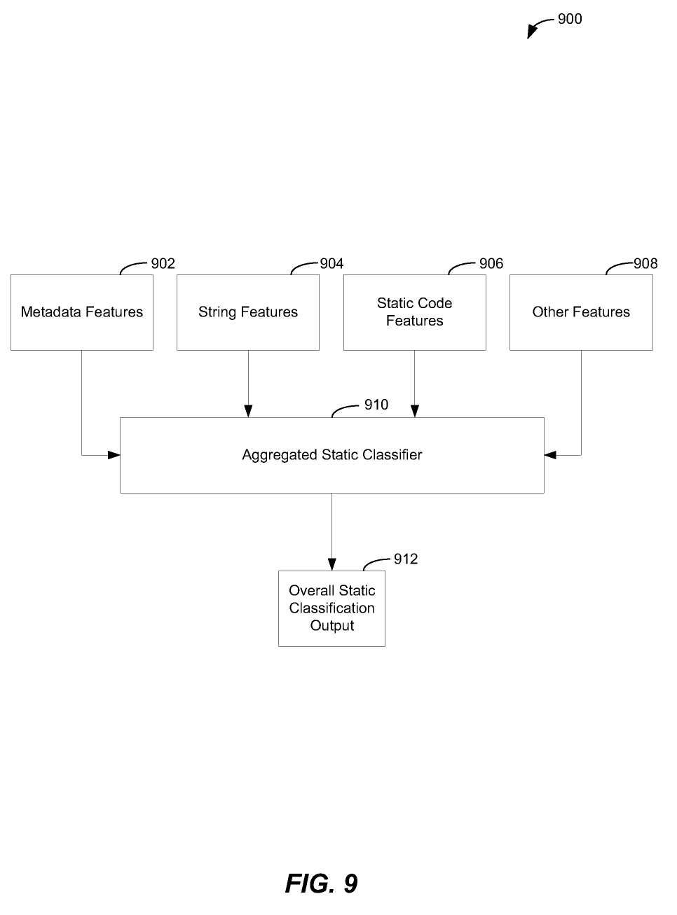

Referring to FIG. 9, a block diagram of a first particular embodiment of an aggregated static classification system is illustrated. One or more metadata features 902, one or more string features 904, one or more static code features 906, and one or more other features 908 are provided to an aggregated static classifier 910. The aggregated static classifier 910 determines an overall static classification output 912.

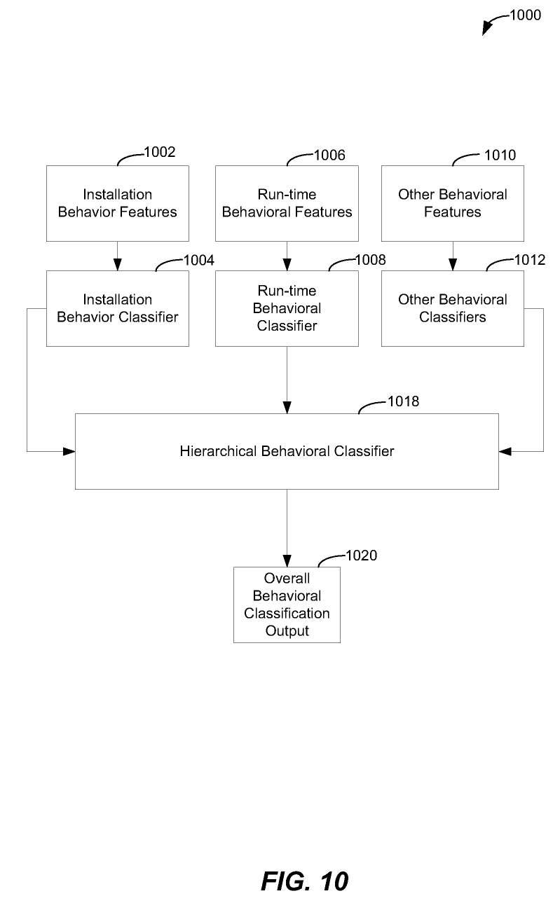

Referring to FIG. 10, a block diagram of a first particular embodiment of a hierarchical behavioral malware classification system is illustrated. One or more installation behavior features 1002 are provided to an installation behavior classifier 1004. One or more run-time behavioral features 1006 are provided to a run-time behavioral classifier 1008. One or more other behavioral features 1010 are provided to other behavioral classifiers 1012. The outputs from each of the classifiers are provided to a hierarchical behavioral classifier 1018. The hierarchical behavioral classifier 1018 determines an overall behavioral classification output 1020.

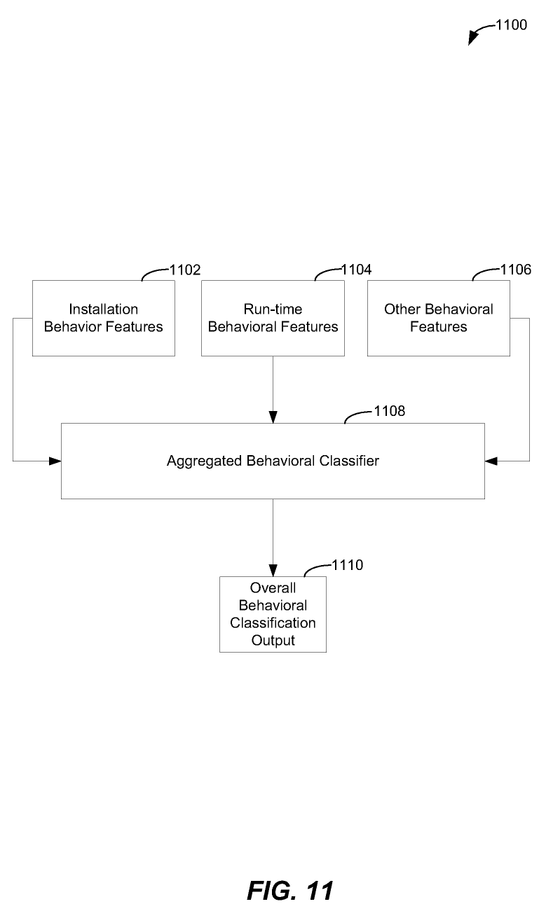

Referring to FIG. 11, a block diagram of a first particular embodiment of an aggregated behavioral classification system is illustrated. One or more installation behavior features 1102, one or more run-time behavior features 1104, and one or more other behavioral features 1106 are provided to an aggregated behavioral classifier 1108. The aggregated behavioral classifier 1108 determines an overall behavioral classification output 1110.

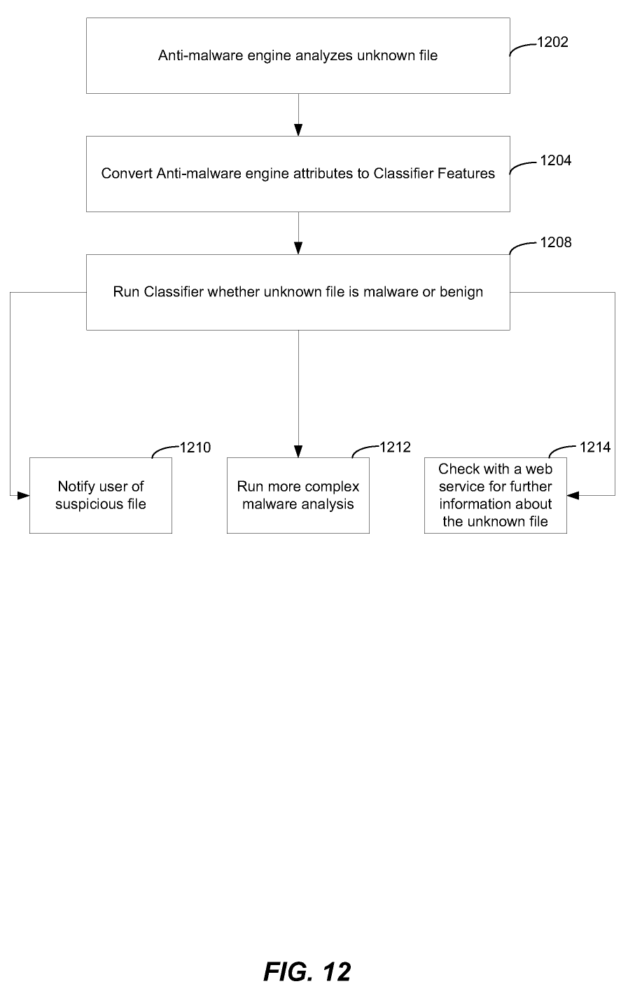

Referring to FIG. 12, a flow diagram of a particular embodiment of a client side malware identification method is illustrated. An anti-malware engine analyzes an unknown file and identifies file attributes, at 1202. The anti-malware engine attributes are converted to classifier features, at 1204. A classifier is run to determine whether the unknown file is malware or benign, at 1208. Based on the classifier determination, an action may be taken. For example, the action may include notifying a user of a suspicious file, at 1210. As another example, the action may include running more complex malware analysis, at 1212. As an additional example, the action may include checking with a web service for further information about the unknown file, at 1214.

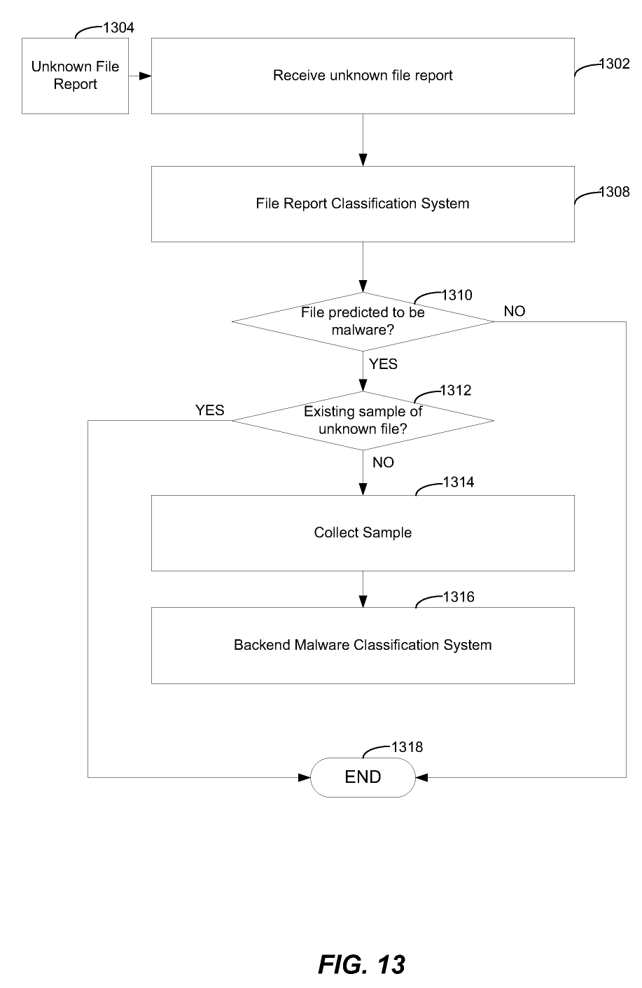

Referring to FIG. 13, a flow diagram of a first particular embodiment of a server side malware identification method is illustrated. The method includes receiving an unknown file report 1304, as shown at 1302. The unknown file report 1304 is provided to a file report classification system, as shown at 1308. The file report classification system determines if the file is predicted to be malware, at 1310. When the file is not predicted to be malware, the method ends at 1318. When the file is predicted to be malware, the report classification system determines if there is an existing sample of the unknown file, at 1312. When there is an existing sample, the method ends at 1318. When there is not an existing sample, a sample of the unknown file is collected, at 1314. The sample of the unknown file is provided to a backend malware classification system, at 1316.

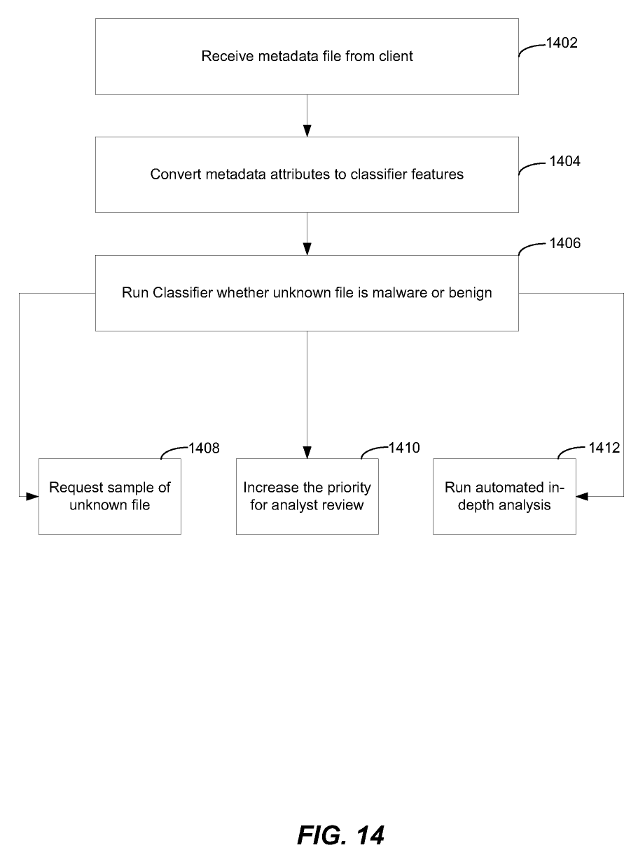

Referring to FIG. 14, a flow diagram of a second particular embodiment of a server side malware identification method is illustrated. The method includes receiving a file from a client, at 1402. Metadata attributes are extracted from the file and converted to classifier features, at 1404. A classifier is run to determine whether the unknown file is malware or benign, at 1406. Based on the classifier determination, an action may be taken. For example, the action may include requesting a sample of the unknown file, at 1408. As another example, the action may include increasing the priority for analyst review, at 1410. As an additional example, the action may include running an automated in-depth analysis, at 1412.

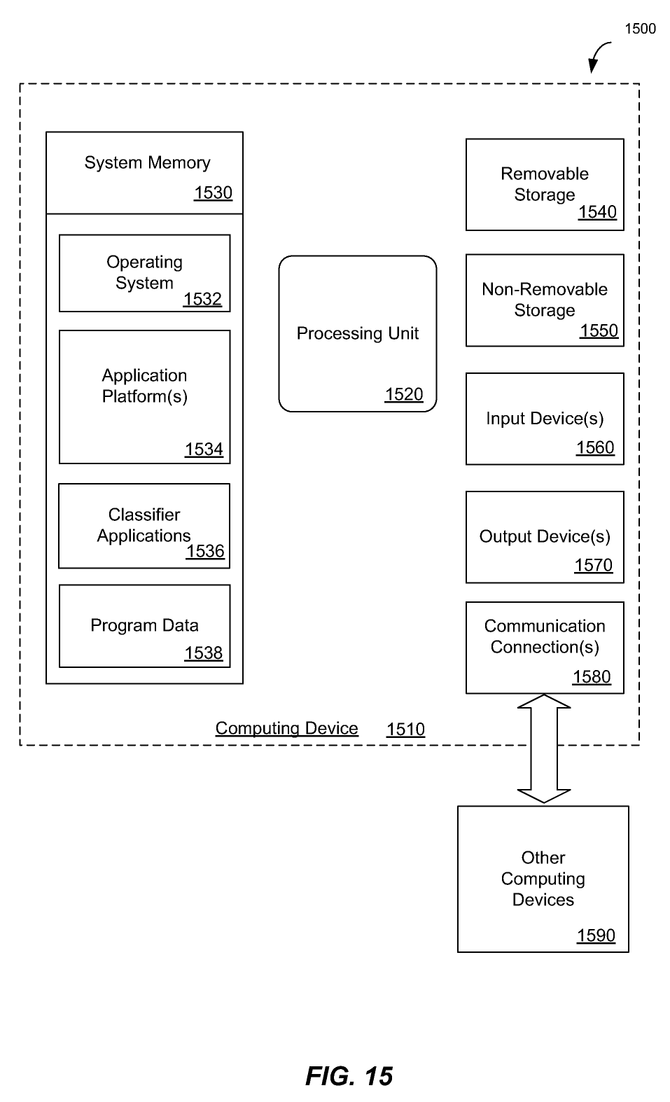

FIG. 15 shows a block diagram of a computing environment 1500 including a general purpose computer device 1510 operable to support embodiments of computer-implemented methods and computer program products according to the present disclosure. In a basic configuration, the computing device 1510 may include a server configured to evaluate unknown files and to apply classifiers to the unknown files, as described with reference to FIGS. 1-14.

The computing device 1510 typically includes at least one processing unit 1520 and system memory 1530. Depending on the exact configuration and type of computing device, the system memory 1530 may be volatile (such as random access memory or “RAM”), non-volatile (such as read-only memory or “ROM,” flash memory, and similar memory devices that maintain the data they store even when power is not provided to them) or some combination of the two. The system memory 1530 typically includes an operating system 1532, one or more application platforms 1534, one or more applications 1536 (e.g., the classifier applications described above with reference to FIGS. 1-14), and may include program data 1538.

The computing device 1510 may also have additional features or functionality. For example, the computing device 1510 may also include removable and/or non-removable additional data storage devices, such as magnetic disks, optical disks, tape, and standard-sized or miniature flash memory cards. Such additional storage is illustrated in FIG. 15 by removable storage 1540 and non-removable storage 1550. Computer storage media may include volatile and/or non-volatile storage and removable and/or non-removable media implemented in any method or technology for storage of information such as computer-readable instructions, data structures, program components or other data. The system memory 1530, the removable storage 1540 and the non-removable storage 1550 are all examples of computer storage media. The computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 1510. Any such computer storage media may be part of the device 1510. The computing device 1510 may also have input device(s) 1560 such as a keyboard, mouse, pen, voice input device, touch input device, etc. Output device(s) 1570 such as a display, speakers, printer, etc. may also be included.

The computing device 1510 also contains one or more communication connections 1580 that allow the computing device 1510 to communicate with other computing devices 1590, such as one or more client computing systems or other servers, over a wired or a wireless network. The one or more communication connections 1580 are an example of communication media. By way of example, and not limitation, communication media may include wired media such as a wired network or direct-wired connection, and wireless media such as acoustic, RF, infrared and other wireless media. It will be appreciated, however, that not all of the components or devices illustrated in FIG. 15 or otherwise described in the previous paragraphs are necessary to support embodiments as herein described.

The steps of a method or algorithm described in connection with the embodiments disclosed herein may be embodied directly in hardware, in a software component executed by a processor, or in a combination of the two. A software component may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of storage medium known in the art. An exemplary storage medium is coupled to the processor such that the processor can read information from, and write information to, the storage medium. In the alternative, the storage medium may be integral to the processor. The processor and the storage medium may reside in an integrated component of a computing device or a user terminal. In the alternative, the processor and the storage medium may reside as discrete components in a computing device or user terminal.

Those of skill would further appreciate that the various illustrative logical blocks, configurations, modules, circuits, and algorithm steps described in connection with the embodiments disclosed herein may be implemented as electronic hardware, computer software, or combinations of both. To clearly illustrate this interchangeability of hardware and software, various illustrative components, blocks, configurations, modules, circuits, or steps have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

A software module may reside in computer readable media, such as random access memory (RAM), flash memory, read only memory (ROM), registers, hard disk, a removable disk, a CD-ROM, or any other form of storage medium known in the art. An exemplary storage medium is coupled to the processor such that the processor can read information from, and write information to, the storage medium.

Although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments.

The previous description of the disclosed embodiments is provided to enable any person skilled in the art to make or use the disclosed embodiments. Various modifications to these embodiments will be readily apparent to those skilled in the art, and the generic principles defined herein may be applied to other embodiments without departing from the scope of the disclosure. Thus, the present disclosure is not intended to be limited to the embodiments shown herein but is to be accorded the widest scope possible consistent with the principles and novel features as defined by the following claims.

What is claimed is:

1. A method of identifying a malware file using multiple classifiers, the method comprising:
receiving a file at a client computer, wherein the file includes static metadata;
applying a set of metadata classifier weights to the static metadata to generate a first classifier output;
initiating a dynamic classifier to evaluate the file and to generate a second classifier output;
automatically identifying the file as potential malware based on at least the first classifier output and the second classifier output.

2. The method of claim 1, wherein the dynamic classifier includes an emulation classifier.

3. The method of claim 2, wherein the emulation classifier simulates execution of the file in an emulation environment.

4. The method of claim 3, wherein the emulation environment protects the client computer from being infected while the file is tested in the emulation environment.

5. The method of claim 3, further comprising:
determining a set of application programming interfaces invoked at the emulation environment; and
determining that at least one application programming interface of the set of application programming interfaces is associated with malware.

6. The method of claim 1, wherein the dynamic classifier includes a behavioral classifier.

7. The method of claim 6, wherein the behavioral classifier analyzes the file during installation to identify one or more installation behavioral features associated with malware.

8. The method of claim 6, wherein the behavioral classifier analyzes the file during run-time to identify one or more run-time behavioral features associated with malware.

9. The method of claim 1, wherein the set of metadata classifier weights is used to produce a statistical likelihood that particular metadata is associated with malware.

10. The method of claim 1, wherein the static metadata is represented as a feature vector, and wherein the first classifier output is determined, at least in part, based on a dot product of the set of metadata classifier weights and the feature vector.

11. A method of classifying a file, the method comprising:
receiving a file at a client computer;
initiating a static type of classification analysis on the file;
initiating an emulation type of classification analysis on the file;
initiating a behavioral type of classification analysis on the file;
taking an action with respect to the file based on a result of at least one of the static type of classification analysis, the emulation type of classification analysis, and the behavioral type of classification analysis.

12. The method of claim 11, wherein the action includes at least one of blocking execution of the file and blocking installation of the file.

13. The method of claim 11, wherein the file is an unknown file, and wherein the action includes providing an indication that the unknown file includes potential malware, wherein the indication is provided via a user interface.

14. The method of claim 11, wherein the action includes querying a web service for additional information about the file.

15. The method of claim 11, wherein the action includes submitting the file for additional emulation type classification analysis to determine whether the file includes malware.

16. A system to classify a file, the system comprising:
a classifier report evaluation component to receive and evaluate a plurality of classifier reports from a set of client computers; and
a hierarchical classifier component, comprising:
a metadata classifier to evaluate metadata of a file sampled by at least one of the client computers to generate a first classifier output;
a dynamic classifier to generate a second classifier output; and
a classifier results output to provide an aggregated output related to predicted malware content of at least one file associated with at least one of the plurality of classifier reports.

17. The system of claim 16, wherein the dynamic classifier includes an emulation classifier and a behavioral classifier.

18. The system of claim 16, wherein an output from the metadata classifier determines a length of time that the dynamic classifier is run.

19. The system of claim 16,
wherein the classifier report evaluation component identifies and prioritizes a set of classifier reports from the plurality of classifier reports and requests sample files associated with the set of classifier reports from at least one of the client computers;
wherein the hierarchical classifier component evaluates each of the set of classifier reports to determine an estimated likelihood that the requested sample files include malware content; and
wherein the classifier report evaluation component ranks the set of classifier reports based on the estimated likelihood that the requested sample files include malware content.

20. A computer-readable medium comprising instructions that, when executed by a computer, cause the computer to:
receive a plurality of files at a client computer;
initiate a static type of classification analysis on the plurality of files;
initiate an emulation type of classification analysis on the plurality of files;
initiate a behavioral type of classification analysis on the plurality of files; and
take an action with respect to the plurality of files based on a result of at least one of the static type of classification analysis, the emulation type of classification analysis, and the behavioral type of classification analysis.
